(19) United States
(12) Patent Application Publication
(10) Pub. No.: US 2009/0302613 A1
(43) Pub. Date: Dec. 10, 2009

(54) POWER GENERATION METHODS AND SYSTEMS

(76) Inventor: Carl Tracy Ullman, Ridgefield, CT (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 12/482,250

(22) Filed: Jun. 10, 2009

Related U.S. Application Data
(60) Provisional application No. 61/060,462, filed on Jun. 10, 2008.
(60) Provisional application No. 61/087,812, filed on Aug. 11, 2008.
(60) Provisional application No. 61/144,565, filed on Jan. 14, 2009.

(51) Int. Cl. F03B 13/10

(52) U.S. Cl. 290/54

(57) ABSTRACT

Methods and Systems are provided for generating electric power. One method includes the steps of: (a) submerging a housing into a body of water, the housing defining a chamber therein; (b) maintaining the chamber at a pressure lower than the pressure exerted by the body of water on the housing; (c) admitting water from the body of water into the chamber, and driving a turbine with the water flowing into the chamber to generate electric power; (d) discharging water from the chamber into the body of water; and (e) sequentially repeating steps (c) and (d).

### CROSS REFERENCE TO RELATED APPLICATIONS

This application claims priority from the following provisional patent applications, all of which are incorporated by reference herein: (1) U.S. Provisional Patent Application Ser. No. 61/060,462, filed on Jun. 10, 2008, entitled Active Hydroelectric Power Device, (2) U.S. Provisional Patent Application Ser. No. 61/087,812, filed on Aug. 11, 2008, entitled Active Hydroelectric Power System With CO₂ Recycling, and (3) U.S. Provisional Patent Application Ser. No. 61/144,565, filed on Jan. 14, 2009, entitled Deep Sea Carbon Dioxide Sequestration Device.

### BACKGROUND

The present application relates to methods and systems for generating electrical power and, more particularly, to hydroelectric power plants and methods of operating such plants.

Hydroelectric power generation is a very efficient and prevalent source of “green” (i.e., clean) energy. Hydropower represents about 20% of the world's electricity production with conversion efficiency rates that exceed 80% compared with fossil fuel facilities, which often operate in the 33% range. Hydroelectric power is an inexpensive way to produce electricity (averaging less than 1 cent per kWh for operations and maintenance) largely because generally no fuel is consumed in the process. This contrasts with nuclear and other thermal processes, which are more costly and deplete valuable resources. Hydroelectric power is also valued as a renewable green energy source since its production does not require the extraction and consumption of any scarce natural resource. Hydropower still represents 75% of the renewable energy produced in the U.S. though other methods such as wind power and solar energy appear to receive greater attention in governmental and industrial programs. Part of the enduring appeal of hydropower rests with its virtually emissions-free production process, its ability to provide both base level and peaking production capacity, its ability to facilitate electrical load balancing, and its ability to store potential electricity in reservoirs for use during the most demanding and lucrative time periods. Hydropower plants have been scaled in size from relatively small sizes such as 10 kW to massive installations as large as 20,000 mW. In recent years, the development of new hydroelectric sites has stalled, particularly in the U.S. Several factors have contributed to this including the previous exploitation of many of the high potential sites, growing environmental concerns regarding the ecological “footprint” of large dam/impoundment complexes, and the relatively high capital costs of new large projects. Environmental concerns with dam/impoundment projects include: loss of habitat from inundation, displacement of indigenous peoples, health concerns in developing countries, disruption of fish migration routes, and oxygen depletion in the dammed rivers. The environmental concerns combined with the high engineering costs, onerous regulatory filing procedures, long lead times, and relatively high capital costs for new construction have inhibited the development of new hydro projects, particularly in the U.S. Even though only 3% of existing U.S. dams have hydroelectric facilities, there is still not much momentum in favor of aggressive exploitation of this potential “green” energy source. Additionally, as water resources become more valuable and greater demands are placed upon the great river systems for conflicting needs such as industrial development, agricultural irrigation, and growing household consumption, hydroelectric use of the limited water resource, though non consumptive, often takes a back seat in timing and actual production to other important societal concerns.

### BRIEF SUMMARY OF EMBODIMENTS OF THE INVENTION

A power generation system in accordance with one or more embodiments includes: a housing defining a chamber therein, the housing being submersible into a body of water; a water intake valve in the housing for admitting water from the body of water into the chamber; a turbine in the housing, the turbine driven by water flowing through the intake valve into the chamber for generating electric power; a conduit coupled to the housing for placing the chamber in communication with the atmosphere for maintaining the chamber at a pressure lower than the pressure exerted by the body of water on the housing; a water outlet valve in the housing for discharging water from the chamber into the body of water; a gas inlet valve in the housing for receiving a compressed gas into the chamber from a source of compressed gas, the compressed gas evacuating water in the chamber into the body of water through the outlet valve as the compressed gas is introduced into the chamber; and a gas outlet valve for evacuating compressed gas in the chamber into the body of water through the gas outlet valve as water is introduced into the chamber from the water intake valve.

A combination power generation system and deep water cooling system in accordance with one or more embodiments includes: a housing defining a chamber therein, the housing being submersible into a body of water; a water intake valve in the housing for admitting water from the body of water into the chamber; a turbine in the housing, the turbine driven by water flowing through the intake valve into the chamber for generating electric power; a conduit coupled to the housing for placing the chamber in communication with the atmosphere for maintaining the chamber at a pressure lower than the pressure exerted by the body of water on the housing; and a water intake unit for evacuating water from the chamber, and transferring the water to a given location.

A power generation system in accordance with one or more embodiments includes: a housing defining a chamber therein, the housing being submersible into a body of water; a water intake valve in the housing for admitting water from the body of water into the chamber; a turbine in the housing, the turbine driven by water flowing through the intake valve into the chamber for generating electric power; a conduit coupled to the housing for placing the chamber in communication with the atmosphere for maintaining the chamber at a pressure lower than the pressure exerted by the body of water on the housing; and an electrolysis unit for evacuating water from the chamber by converting the water into hydrogen and oxygen gases, and discharging the hydrogen and oxygen gases from the chamber.

A method for generating power in accordance with one or more embodiments includes the steps of: (a) submerging a housing into a body of water, the housing defining a chamber therein; (b) maintaining the chamber at a pressure lower than the pressure exerted by the body of water on the housing; (c) admitting water from the body of water into the chamber, and driving a turbine with the water flowing into the chamber to generate electric power; (d) discharging water from the chamber into the body of water; and (e) sequentially repeating steps (c) and (d).

A power generation system in accordance with one or more embodiments includes: a power generation unit submersible into a body of water, the power generation unit including a housing defining at least one chamber therein, the power generation unit further including one or more turbines for generating electric power; a platform adapted to float on the surface of the body of water, the platform including a heater for heating water from the body of water; an evaporator or vacuum pump assisted regulating unit; a plurality of conduits coupling the platform and the power generation unit, the plurality of conduits including a water conduit, a steam conduit, and an air supply conduit; wherein heated water from the platform flows through the water conduit to the power generation unit to drive the one or more turbines for generating electric power, the water thereafter flowing to a hot water chamber in the housing; wherein the evaporator or vacuum pump assisted regulating unit facilitates evaporation of the water in the hot water chamber into steam that is drawn out of the power generation unit through the steam conduit.

A method for generating power in accordance with one or more embodiments includes the steps of: (a) submerging a housing into a body of water, the housing defining a chamber therein; (b) maintaining the chamber at a pressure lower than the pressure exerted by the body of water on the housing; (c) heating water from the body of water into heated water; (d) dropping the heated water into the chamber, and driving one or more turbines with the water flowing into the chamber to generate electric power; (e) evaporating the heated water into steam and transferring the steam out of the housing; and (f) sequentially repeating steps (c), (d), and (e).

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1A is a cross-section view of a submersible power generation unit in accordance with one or more embodiments of the invention shown in one state of operation.

FIG. 1B is a cross-section view of the submersible power unit of FIG. 1A shown in another state of operation.

FIG. 2A is a perspective view of a known water intake unit of a deep lake water cooling system.

FIG. 2B is a cross-section view of a submersible power generation unit in accordance with one or more embodiments of the invention that can be implemented in the intake unit of the deep lake water cooling system illustrated in FIG. 2A.

FIG. 2C is a cross-section view of an alternate submersible power generation unit in accordance with one or more embodiments of the invention that can be implemented in the intake unit of the deep lake water cooling system illustrated in FIG. 2A.

FIG. 3 is a cross-section view of a submersible power generation unit in accordance with one or more further embodiments of the invention.

FIG. 4 is a cross-section view of a power generation system in accordance with one or more further embodiments of the invention.

Like reference characters denote like parts in the drawings.

### DETAILED DESCRIPTION

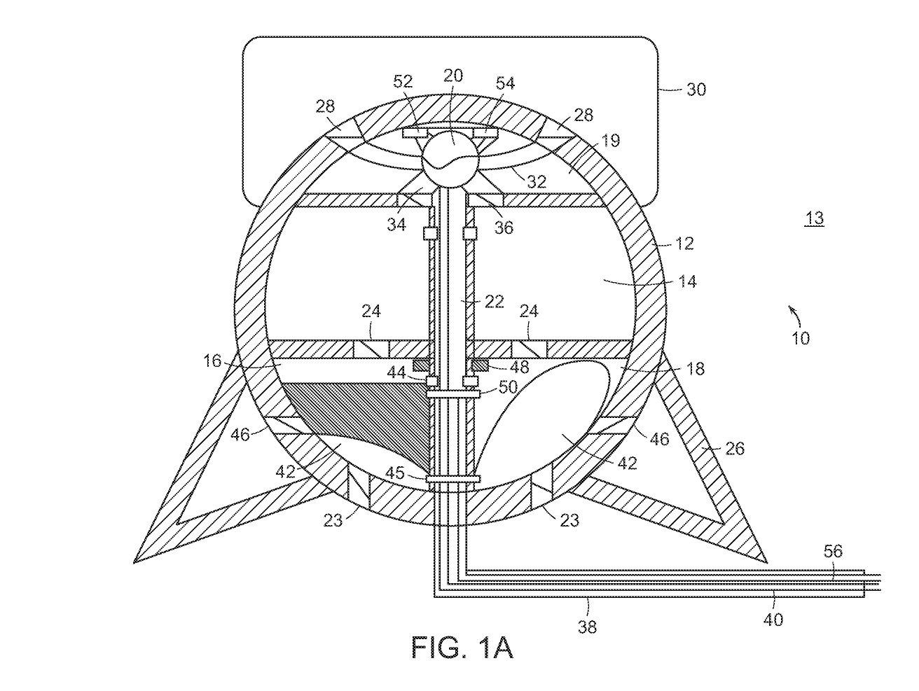

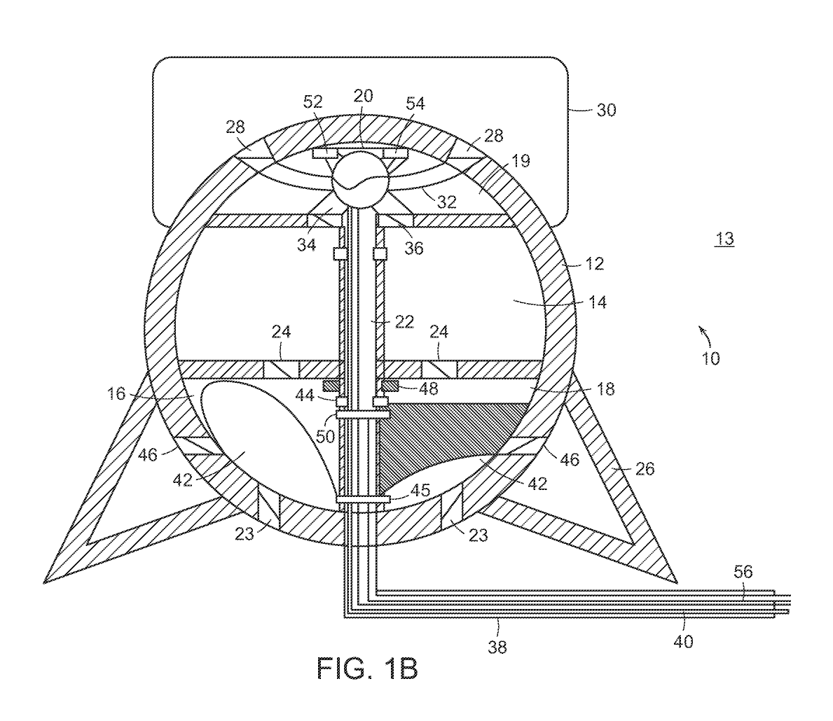

FIGS. 1A and 1B illustrate a combined power generation and gas sequestration unit 10 in accordance with one or more embodiments of the invention. FIGS. 1A and 1B illustrate the unit 10 in two states of operation, as will be described in further detail below. The unit 10 includes a housing 12 comprising a sealed vessel submerged in a body of water 13 such as a lake or ocean. The housing 12 defines a chamber therein, which preferably includes one or more upper compartments and one or more lower compartments. In the embodiment illustrated in FIGS. 1A and 1B, there is one upper compartment 14 and two lower compartments 16, 18. In addition, the housing 12 defines a compartment 19 having one or more turbines 20 therein. Water is admitted from the body of water 13 into the housing 12 into the compartment 19 at the high ambient pressure in the body of water 13. The water passes through and drives the one or more turbines 20 in a conventional hydroelectric power generating cycle. The upper compartment 14 of the unit 10 is in communication with the outer atmosphere through an air conduit 22 and thereby maintains a generally constant pressure of about one atmosphere (14.7 psi). Water that has flowed through the turbines 20 (i.e., “spent” water) thereby falls by gravity into the upper compartment 14 of the unit 10.

The spent water is discharged from upper compartment 14 through the sequential opening and closing of one-way pressure valves 24 in the upper compartment floor permitting the spent water to fall into the lower compartments 16, 18. The spent water fills the lower compartments 16, 18, and is subsequently evacuated from the lower compartments 16, 18 by introducing a high-pressure carbon dioxide gas into the lower compartments 16,18 to force the spent water out of the housing 12 and into the body of water 13. The lower compartments 16, 18 are alternatingly filled with the spent water received from the upper compartment 14 and then emptied of the spent water. Water can thereby continue to flow from the body of water 13 into the upper compartment 14 and drive the turbine 20 to generate electricity.

The housing 12 is submerged in the body of water 13, preferably at a depth greater than 2800 feet. The housing 12 accordingly comprises a structure that can withstand high-pressure and corrosive conditions found in a deepwater environment. The housing 12 preferably has the general shape of a sphere, an ovoid, or a cylinder, and comprises materials and wall thicknesses suitable for use in deepwater environments, as is well known in the ocean oil drilling industry. In some cases it may be possible to use inexpensive plastic materials including HDPE (high density polyethylene) materials, particularly for units submerged at shallower depths. The housing 12 can be secured to the floor of the body of water 13, e.g., by being tethered or anchored to the floor. The housing 12 can be supported on the floor using adjustable support legs 26.

The housing 12 includes one or more water intake valves 28. When the intake valves 28 are opened, water from the body of water 13 is admitted into the housing. A screen 30 is preferably provided around the intake valves to filter out indigenous aquatic material and inhibit it from being ingested into the unit 10 via the vortex of water at the intake valves 28.

The water is conveyed down one or more penstocks 32 into the turbine 20 by the high ambient pressure of the deep water environment. The high-pressure water drives and spins the turbine 20, converting the deep water's potential energy into kinetic energy. The spinning elements of the turbine 20 are connected by a shaft to a generator that converts the kinetic energy into electricity via induction as is known in the art. By way of non-limiting example, the turbine 20 can comprise a Pelton wheel system, which at high hydraulic heads, is known to operate at particularly high efficiencies.

Once the water has passed through the turbine 20, it is conveyed by gravity through generator effluent conduits 34 and gravity intake check valves 36 into the upper compartment 14 of the housing 12. As discussed above, the upper compartment 14 of the housing 12 is in communication with the outer atmosphere through an air conduit 22 in a main conduit 38, and accordingly maintains a pressure of about 14.7 psi or one atmosphere. The spent water accordingly flows into the lower-pressure upper chamber 14 and becomes trapped in the chamber 14 by the one-way gravity check valves 24. The check valves 24 are then opened from time to time to transfer the water from the upper compartment 14 to the lower compartments 16, 18 as discussed below. The electricity generated by the turbine 20 is transmitted from the housing 12 via the electrical lines 40 in the main conduit 38 to a location where it can be used by the outside world.

In accordance with one or more embodiments, the spent water is evacuated from the lower compartments 16, 18 into the body of water 13 using highly compressed carbon dioxide gas to force the water out of the housing 12. This expulsion process is similar to the process a submarine uses to “blow” its main ballast tank with highly-compressed air in order to allow the submarine to ascend to the water's surface.

The carbon dioxide gas is then also expelled into the body of water 13, thereby sequestering the carbon dioxide, which is a known greenhouse gas pollutant. The system thereby makes a synergistic connection between the need to reduce greenhouse gas pollution and provide a new source of cleanly generated electricity. It has been found when carbon dioxide is expelled at depths greater than roughly 2800 feet, the carbon dioxide gas changes into a hydrate, which generally stays pooled at the bottom of the body of water 13 rather than returning to the surface as a gas to pollute the atmosphere.

FIGS. 1A and 1B illustrate the two states of operation in which the carbon dioxide and spent water are alternatingly expelled from the lower compartments 16, 18 of the housing. As shown, the lower compartments 16, 18 each include an expandable bladder 42, which separates the spent water from the carbon dioxide. In the state shown in FIG. 1, the lower left compartment 16 is substantially filled with spent water, and the bladder 42 is substantially flattened. In the lower right compartment 18, however, the bladder 42 has been inflated with carbon dioxide, forcing the spent water out of the housing 12. FIG. 1B illustrates a subsequent state of operation in which, in the lower left compartment 16, the bladder 42 has been inflated with carbon dioxide to force out the spent water, and in the lower right compartment 18, spent water has been admitted and substantially flattens the bladder 42. The process is repeated such that spent water is alternatingly admitted and expelled from the lower compartments 16, 18.

As discussed above, the upper compartment 14 is maintained at a pressure of about 14.7 psi using the air conduit 22 at valve opening 44. Spent water in the upper compartment 14 moves via gravity through one-way pressure check valve 24 into the lower compartments 16, 18. Pressure in the lower compartments 16, 18 need not be at 14.7 psi, but should be conducive to the entry of water by gravity from the upper compartment in order to permit continuous operation. Once a lower compartment 16, 18 is substantially filled with water, high pressure carbon dioxide gas is introduced from inlet valve 45 into bladder 42, thereby inflating the bladder under great pressure and forcing the spent water out of the housing via valves 46 and into the body of water 13. Once a lower compartment is vacated of the spent water, new spent water can be admitted via valve 24.

The weight of the spent water entering from the upper compartment 14 will flatten the bladder 42, thereby substantially forcing residual carbon dioxide left in the bladder 42 out of the housing 12 via valves 23. The unit 10 includes one or more monitoring sensors 48 to monitor the pressure in lower compartment 16, 18 such that appropriate thermodynamic conditions can be maintained to permit water flow through the lower compartments 16, 18. In the event that the monitoring sensors 48 detect carbon dioxide residue in the bladder 42 sufficient to inhibit flow from the upper compartment 14, an electronic control unit 52 coupled to the sensors 48 can actuate the introduction of auxiliary high pressure compressed air into the lower compartment 16, 18 from valve 50 to clear the compartment. Any residual compressed air can be purged into the 14.7 psi air conduit 22 and out into the external environment.

Operation of the power generation unit 10, including control of the valves to admit and expel water in the compartments, can be controlled using the electronic control unit 52 in the housing 12. An additional redundant electronic control unit 54 can be provided in the event the primary control unit 52 fails.

The main conduit 38 can comprise a rigid or flexible tube depending on the water pressures involved. The main conduit 38 can extend vertically from the housing 12 or extend laterally to a land location along the floor of the body of water 13.

The compressed carbon dioxide gas is provided to the power generation unit 10 via a carbon dioxide supply conduit 56 in the main conduit 38 from a remote carbon dioxide source. The compressed air used for clearing residual carbon dioxide gas can be produced on site at the power generation unit 10 using an air compressor, or alternately can be received from a remote compressed air source.

In accordance with one or more embodiments, the power generation unit 10 may be raised to the water surface level for maintenance or refurbishing, as needed. Techniques for raising the unit 10 include connecting the unit with the cable to mechanically lift the unit 10 and using gas-induced buoyancy to raise the unit 10.

In accordance with one or more further embodiments of the invention, a power generation unit is provided that may be implemented with the intake unit of a deep water cooling system. Such systems have been used to pump cold water from a deep location in a lake or ocean to a land location where it can be used for cooling purposes. Examples of such systems are Cornell University's deep lake cooling system and the NELHA deep ocean pipeline.

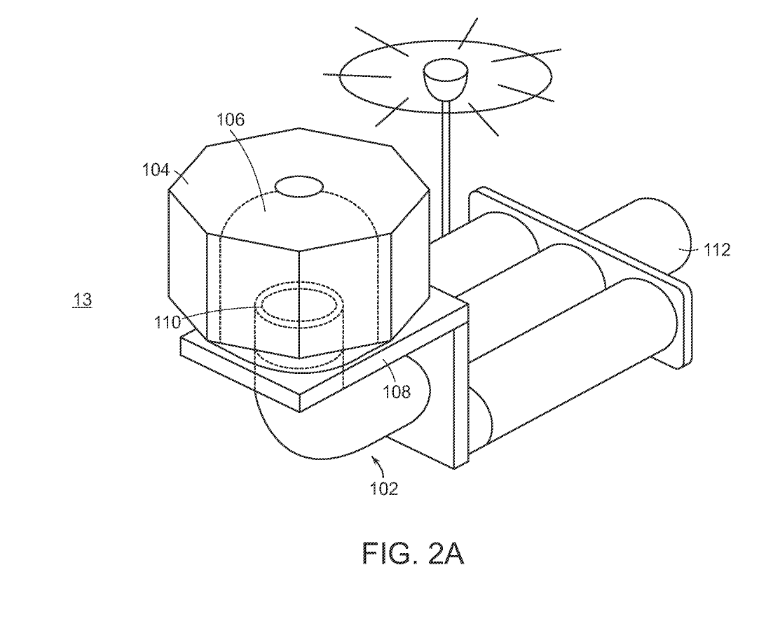

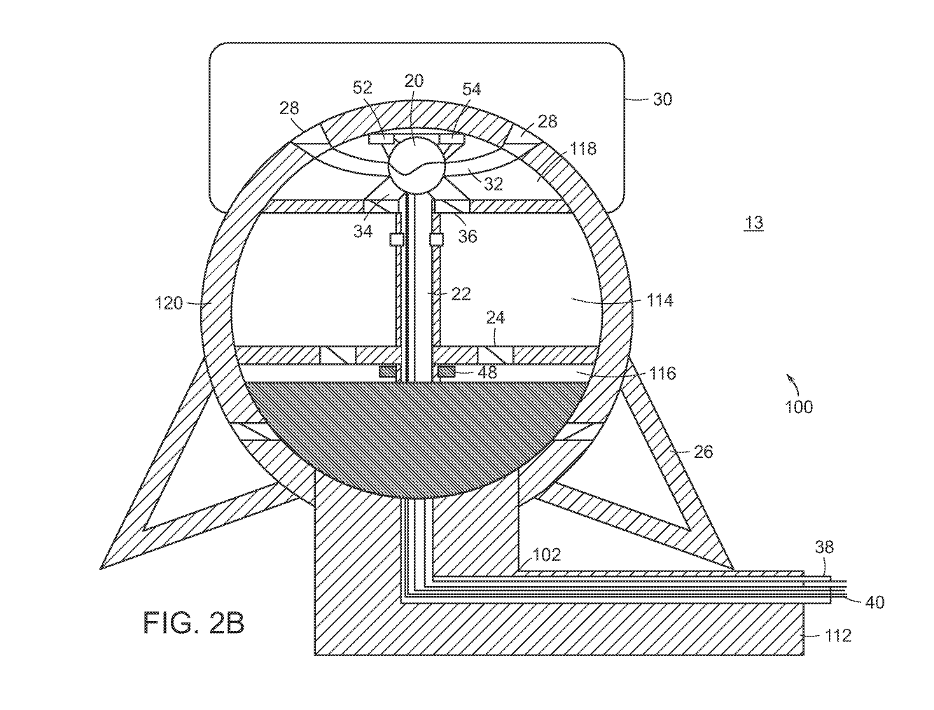

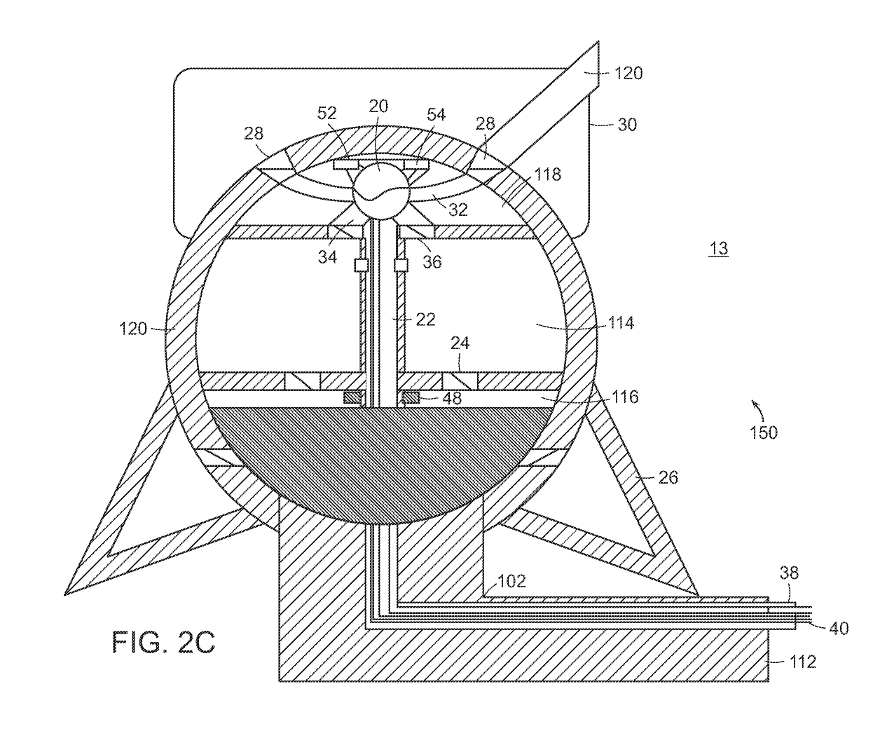

FIG. 2A illustrates an exemplary intake unit 102 of a deep water cooling system. The intake unit includes an outer screen 104 and an inner cover 106, both positioned on a platform 108 for covering a water intake pipe opening 110. Water is drawn from the lake or ocean through the intake pipe opening 110, and pumped to a location where it can be used via pipe 112.

FIG. 2B illustrates a power generation unit 100 that is configured to be implemented in the intake unit of a deep water cooling system such as the unit 102 illustrated in FIG. 2A. In the FIG. 2A exemplary intake unit 102, the outer screen 104, the inner cover 106, and the platform 108, are removed to expose the water intake pipe opening 110. The water intake pipe opening 110 is incorporated in the power generation unit 100 depicted in FIG. 2B for the purpose of evacuating spent water from the unit 100.

The unit 100 illustrated in FIG. 2B includes an upper compartment 114 and a lower compartment 116. In addition, the unit 100 includes a compartment 118 having one or more turbines 20. Water is admitted from the body of water 13 into the housing 120 into the compartment 118 at the high ambient pressure in the body of water 13. The water passes through and drives one or more turbines 20 in a conventional hydroelectric power generating cycle. The upper compartment 114 of the unit 100 is in communication with the outer atmosphere through an air conduit 22 and thereby maintains a generally constant pressure of about one atmosphere (14.7 psi). The water that has flowed through the turbine 20 (i.e., “spent” water) thereby falls by gravity into the upper compartment 114 of the unit 100. The spent water is discharged from upper compartment 114 through the one-way pressure valves 24 in the upper compartment floor permitting the spent water to fall into the lower compartment 116. The spent water fills the lower compartment 116, and is subsequently evacuated from the lower compartment 116 by the water intake pipe 112 of the deep water cooling system.

The attachment of the power generation unit 100 to the intake of a preexisting deep water cooling system offers the opportunity to partially defray the cost of the system through the production of electricity. The unit 100 operates similarly to the unit 10 shown in FIGS. 1A and 1B.

FIG. 2C illustrates a power generation unit 150 in accordance with one or more alternate embodiments of the invention. The power generation unit 150 is similar to the power generation unit 100 shown in FIG. 2B. In the unit 150, the spent water that has flowed through the turbine 20 and drawn by the pipe 112 to a land location is recirculated and returned to the unit 150 by a return pipe 120. Additional water can be drawn into the unit as needed to account for any water losses in transportation of the water. Recirculating the spent water reduces environmental impact on the body of water 13.

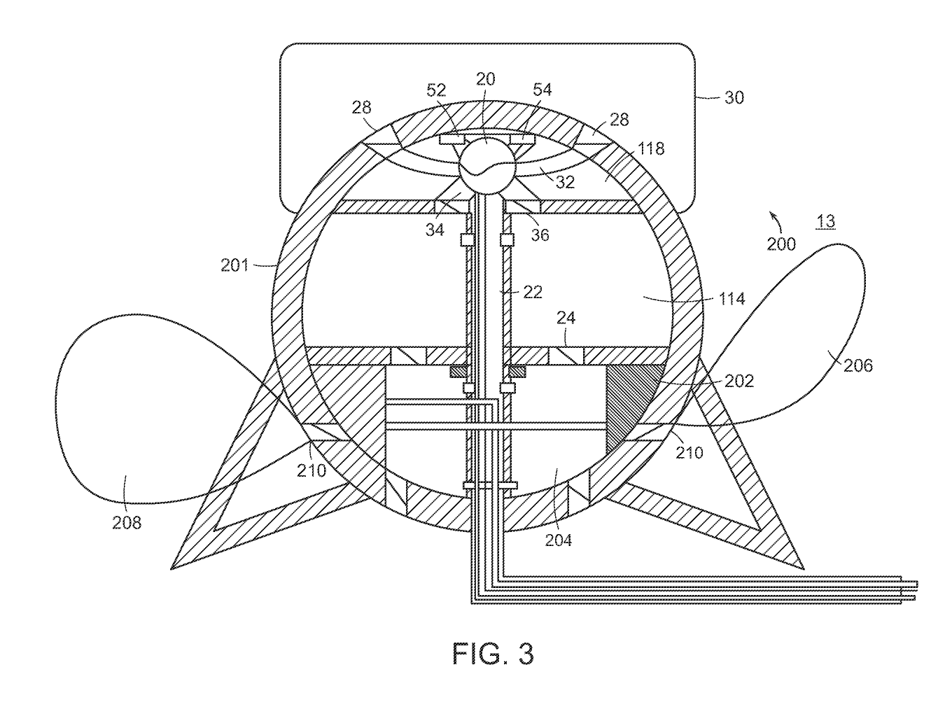

FIG. 3 illustrates a power generation unit 200 in accordance with one or more further embodiments of the invention. The unit 200 includes a housing 201 having an upper compartment 114 and a lower compartment 204. In addition, the unit 200 includes a compartment 118 having one or more turbines 20. Water is admitted from the body of water 13 into the housing 201 into the compartment 118 at the high ambient pressure in the body of water 13. The water passes through and drives one or more turbines 20 in a conventional hydroelectric power generating cycle. The upper compartment 114 of the unit 200 is in communication with the outer atmosphere through an air conduit 22 and thereby maintains a generally constant pressure of about one atmosphere (14.7 psi). The water that has flowed through the turbine 20 (i.e., “spent” water) thereby falls by gravity into the upper compartment 114 of the unit 200. The spent water is discharged from upper compartment 114 through the one-way pressure valves 24 in the upper compartment floor permitting the spent water to fall into the lower compartment 204. The unit 200 discharges spent water through electrolysis. In particular, electrolysis is used to separate the water into its elemental parts: oxygen and water.

The power generation unit 200 includes an electrolysis unit 202 in a lower compartment 204 for converting the spent water in the lower compartment 204 into hydrogen and oxygen. Once this conversion has been accomplished (preferably at least partially using electricity created locally by the turbine 20), the elemental parts, hydrogen and oxygen, are bubbled into deep-water high pressure storage containers 206 and 208, respectively, attached to the housing via valves 210. Once created, the hydrogen and oxygen may be packaged for sale off-site or converted into useful products such as ammonia through further processing.

By way of non-limiting example, the electrolysis unit 202 includes a homopolar generating device rather than a more typical generator. The homopolar generator or Faraday disk is particularly well-adapted to situations of water electrolysis since it creates more suitable conditions for large-scale production, namely enormous amperage at nominal voltage. In this case, it is the amperage that determines how much water can be cracked so the large amperage afforded by the homopolar system is well suited for this purpose.

In accordance with one or more embodiments, an on-site ammonia production unit is optionally included in the housing to generate ammonia from the hydrogen using nitrogen filtered from the surrounding air. Some of the electricity produced by the unit 200 can be used to support the energy needs of the ammonia production process. As ammonia has been shown to be very economically useful as the primary component of fertilizer and even as a “green” fuel for vehicles that burns without noxious effluent, making it generally continuously in a non-polluting green fashion is particularly advantageous.

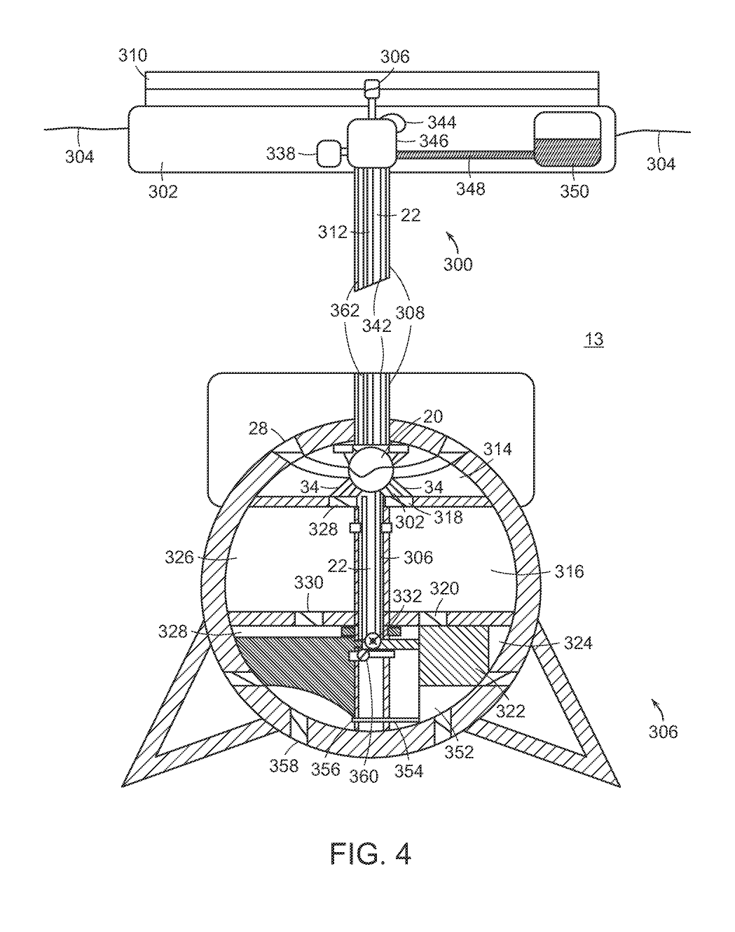

FIG. 4 illustrates a power generation system 300 in accordance with one or more further embodiments of the invention. The system 300 includes a platform 302, which floats at the surface 304 of the body of water 13, and a power generation unit 306, which is submerged at a given depth in the body of water 13. The platform 302 and the power generation unit 306 are connected by a main conduit 308.

The platform 302 includes a solar thermal device 310 for heating water. Water is collected at the surface 304 of the body of water 13 and processed through the solar thermal device 310. By way of non-limiting example, the solar thermal device 304 can be a solar parabolic reflector. Once heated, water is allowed to pass by gravity through a sensor valve 306, where it is permitted to flow through only when heated to a desired temperature, which can be approximately 212° F. In some embodiments, higher temperatures can be used if the water stays in a liquid state and is not converted to steam (e.g., superheated water). While still in the liquid state, the water is allowed to drop through conduit 312 located inside of the main conduit 308. The conduit 312 is preferably insulated to reduce thermal losses.

The water flowing through the conduit 312 flows to one or more turbines 20 in a compartment 314 in the unit 306. Once the force of the water's mass has spun the turbine and contributed its kinetic energy to the production of electricity, the still hot water is allowed to fall by gravity into an upper chamber 316 through a gravity check valve 318. The hot water continues to fall by gravity through pressure check valve 320 into the hot water collection sump 322 in a lower compartment 324 of the unit 306.

At the same time water at a cold deep water temperature is admitted into the unit 306 through the penstock valve 28. The cold water passes through and drives one or more turbines 20. The “spent” cold water falls by gravity to an upper chamber 316 through a gravity check valve 328. The cold water continues to fall by gravity through a pressure check valve 330 into a lower compartment 328 of the unit 306. In some embodiments, the spent cold water can be expelled from the chamber 328 back into the body of water 13 using any of the evacuation techniques described herein. In other embodiments as described below, some or all of the cold water is mixed with the water heated by the solar thermal device, and subsequently evaporated and evacuated from the housing.

The hot water in the hot water collection sump 322 of chamber 324 and the cold water in chamber 328 are allowed to flow into a steam/water mixing valve 332 where a suitable amount of the cold water is mixed with the hot water to achieve a controlled temperature between approximately 165° F. and 212° F. Using known evaporation techniques, the hot water is permitted to evaporate up through a conduit 342 in the main conduit 308. The flow of the steam through the conduit 342 may be assisted by a vacuum pump-assisted regulating unit 344, which lowers the pressure at the upper outlet of the conduit 342 and provides the thermodynamic impetus for the hot water to evaporate and move up the conduit 342 via the “stack” effect. Alternatively, an evaporator can be used to evaporate the hot water. A heat exchange and condensation chamber 346 condenses the vapor and the high heat content of the vapor is transferred through a proximal heat exchange process to input water from the body of water 13, which is fed to the solar thermal device 310. With the structure, a significant portion, e.g., 75% of the heat previously added is conserved for use in the next hot water to vapor cycle. Once condensed, the vapor comprises distilled water. The distilled water can be conveyed in a conduit 348 to distilled water tank 350. From the storage tank 350, the water may be exported for outside consumption purposes including drinking, irrigation etc.

In the case of saline water or particularly mineral-rich fresh water, a blow down cycle can be used from the tank at the bottom of the hot water collection sump 322. The resulting mineral-rich blow down effluent is collected in a blow down tank 352 and transferred via conduit 354 to valve 356 from which it is directed under a bladder 42. The weight of the incoming water atop the bladder 42 expels the blow down effluent into the surrounding aqueous environment 13 via a pressure check valve 358. If additional force is needed to expel the effluent, highly compressed air may be added through air compressor 360 attached to compressed air conduit 362.

In some embodiments, a combination of evacuation techniques to discharge spent water from the power generation units can be used. For example, a power generation unit can include any combination of the water expulsion techniques described herein.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A power generation system, comprising:
a housing defining a chamber therein, the housing being submersible into a body of water;
a water intake valve in the housing for admitting water from the body of water into the chamber;
a turbine in the housing, the turbine driven by water flowing through the intake valve into the chamber for generating electric power;
a conduit coupled to the housing for placing the chamber in communication with the atmosphere for maintaining the chamber at a pressure lower than the pressure exerted by the body of water on the housing;
a water outlet valve in the housing for discharging water from the chamber into the body of water;
a gas inlet valve in the housing for receiving a compressed gas into the chamber from a source of compressed gas, the compressed gas evacuating water in the chamber into the body of water through the outlet valve as the compressed gas is introduced into the chamber; and
a gas outlet valve for evacuating compressed gas in the chamber into the body of water through the gas outlet valve as water is introduced into the chamber from the water intake valve.

2. The power generation system of claim 1, wherein the chamber comprises a first compartment and a second compartment, wherein water flows from the turbine into the first compartment, and thereafter through a check valve into the second compartment, wherein the second compartment includes the water outlet valve, the gas inlet valve, and the gas outlet valve.

3. The power generation system of claim 2, further comprising a resilient bladder in the second compartment separating the compressed gas and the water, wherein the bladder is inflated with the compressed gas introduced into the chamber to evacuate water in the second compartment into the body of water.

4. The power generation system of claim 1, wherein the compressed gas comprises compressed carbon dioxide.

5. The power generation system of claim 1, wherein the housing generally has the shape of a sphere, an ovoid, or a cylinder.

6. The power generation system of claim 1, further comprising a screen at the water intake valve for filtering water entering the housing through the water intake valve.

7. The power generation system of claim 1, further comprising a monitor to detect the presence of excess residual compressed gas in the bladder, and further comprising source of an additional compressed gas to substantially purge the chamber of the excess residual compressed gas.

8. The power generation system of claim 1, further comprising a control system for controlling in an alternating fashion the introduction of water in the chamber and the resulting evacuation of compressed gas from the chamber, and the introduction of compressed gas in the chamber and the resulting evacuation of water from the chamber.

9. A combination power generation system and deep water cooling system, comprising:
a housing defining a chamber therein, the housing being submersible into a body of water;
a water intake valve in the housing for admitting water from the body of water into the chamber;
a turbine in the housing, the turbine driven by water flowing through the intake valve into the chamber for generating electric power;
a conduit coupled to the housing for placing the chamber in communication with the atmosphere for maintaining the chamber at a pressure lower than the pressure exerted by the body of water on the housing; and
a water intake unit for evacuating water from the chamber, and transferring the water to a given location.

10. A power generation system, comprising:
a housing defining a chamber therein, the housing being submersible into a body of water;
a water intake valve in the housing for admitting water from the body of water into the chamber;
a turbine in the housing, the turbine driven by water flowing through the intake valve into the chamber for generating electric power;
a conduit coupled to the housing for placing the chamber in communication with the atmosphere for maintaining the chamber at a pressure lower than the pressure exerted by the body of water on the housing; and
an electrolysis unit for evacuating water from the chamber by converting the water into hydrogen and oxygen gases, and discharging the hydrogen and oxygen gases from the chamber.

11. The power generation system of claim 10, further comprising storage containers for separately storing the hydrogen and oxygen gases discharged from the chamber.

12. The power generation system of claim 10, further comprising an ammonia production unit for generating ammonia using the hydrogen.

13. A method for generating power, comprising:
(a) submerging a housing into a body of water, the housing defining a chamber therein;
(b) maintaining the chamber at a pressure lower than the pressure exerted by the body of water on the housing;
(c) admitting water from the body of water into the chamber, and driving a turbine with the water flowing into the chamber to generate electric power;
(d) discharging water from the chamber into the body of water; and
(e) sequentially repeating steps (c) and (d).

14. The method of claim 13, wherein step (d) comprises admitting a compressed gas into the chamber to evacuate the water from the chamber into the body of water, and subsequently discharging the compressed gas into the body of water.

15. The method of claim 14, wherein the compressed gas comprises carbon dioxide.

16. The method of claim 13, wherein step (d) comprises transporting the water from the chamber to a remote location in a deep water cooling system.

17. The method of claim 13, wherein step (d) comprises converting the water into hydrogen and oxygen gases, and discharging the hydrogen and oxygen gases from the chamber.

18. The method of claim 17, further comprising transporting the hydrogen and oxygen gases discharged from the chamber to a remote location.

19. The method of claim 17, further comprising generating ammonia using the hydrogen.

20. A power generation system, comprising:
a power generation unit submersible into a body of water, the power generation unit including a housing defining at least one chamber therein, the power generation unit further including one or more turbines for generating electric power;
a platform adapted to float on the surface of the body of water, the platform including a heater for heating water from the body of water;
an evaporator or vacuum pump assisted regulating unit;
a plurality of conduits coupling the platform and the power generation unit, the plurality of conduits including a water conduit, a steam conduit, and an air supply conduit;
wherein heated water from the platform flows through the water conduit to the power generation unit to drive the one or more turbines for generating electric power, the water thereafter flowing to a hot water chamber in the housing;
wherein the evaporator or vacuum pump assisted regulating unit facilitates evaporation of the water in the hot water chamber into steam that is drawn out of the power generation unit through the steam conduit.

21. The power generation system of claim 20, further comprising a condensation unit for condensing steam from the power generation unit into distilled water, and further comprising a tank for storing the distilled water.

22. The power generation system of claim 21, wherein the condensation unit further comprises a heat exchanger for transferring heat from the steam to the water flowing to the heater.

23. The power generation system of claim 20, wherein the heater comprises a solar heater.

24. The power generation system of claim 20, wherein the power generation unit further comprises a water intake valve for admitting water from the body of water and driving the one or more turbines, wherein at least a portion of the water received from the water intake valve is mixed with water from the hot water chamber and evaporated.

25. The power generation system of claim 20, further comprising a blow down unit for collecting and expelling effluent from the power generation unit.

26. A method for generating power, comprising:
(a) submerging a housing into a body of water, the housing defining a chamber therein;
(b) maintaining the chamber at a pressure lower than the pressure exerted by the body of water on the housing;
(c) heating water from the body of water into heated water;
(d) dropping the heated water into the chamber, and driving one or more turbines with the water flowing into the chamber to generate electric power;
(e) evaporating the heated water into steam and transferring the steam out of the housing; and
(f) sequentially repeating steps (c), (d), and (e).

27. The method of claim 26, further comprising condensing the steam to form distilled water.

28. The method of claim 26, wherein step (c) is performed using a solar heater.

29. The method of claim 26, wherein step (e) is performed using a vacuum pump assisted regulating unit to lower pressure in a conduit extending from the housing for transferring the steam or an evaporator.

30. The method of claim 26, further comprising admitting water into the housing from the body of water and driving the one or more turbines, wherein at least a portion of the water is mixed with the heated water to be evaporated.
